(19) United States
(12) Patent Application Publication
(10) Pub. No.: US 2015/0118641 A1
(43) Pub. Date: Apr. 30, 2015

(54) TITANIUM AND TITANIUM ALLOYS FOR A DENTAL MATRIX BAND

(71) Applicant: Fly Cast Technologies, Inc., Libertyville, IL (US)

(72) Inventor: Robert E. Haraden, Libertyville, IL (US)

(73) Assignee: Fly Cast Technologies, Inc., Libertyville, IL (US)

(21) Appl. No.: 14/068,166

(22) Filed: Oct. 31, 2013

(51) Int. Cl. A61C 5/12

(52) U.S. Cl. CPC A61C 5/125
USPC 433/39; 427/2.29

(57) ABSTRACT

A matrix band, including a straight, contoured or sectional matrix band for use in dentistry is described. The matrix band includes a metal or metal alloy strip constructed from titanium, titanium alloy or stainless steel plated with titanium or titanium alloy, which initiates coagulation of the blood, while the polymer coating eliminates capillary action between a tooth and the matrix band while the tooth is being filled.

### TECHNICAL FIELD OF THE INVENTION

The present device relates to a dental matrix band, also known in the industry as a separating strip, having a barrier coating thereon for use in dentistry. More particularly, the device relates to a dental matrix band having a base metal of titanium, titanium alloy or stainless steel plated or coated with titanium or titanium alloy to initiate coagulation of blood and reduce bleeding into the work area.

### BACKGROUND OF THE INVENTION

A matrix band, which is one component of the matrix system, is a common tool used in dentistry. Matrix bands are typically used to isolate parts of or all of a particular tooth to either protect adjacent teeth during a restoration procedure, or to contain a restorative material before curing. Typically, the matrix band is a thin, flexible piece of material. Generally speaking, the matrix band is metallic in nature. A dentist will position the band around a tooth to be filled. The band is then tightened around the tooth, with a clamping device, in order to form a mold or an appropriate support for applying a filling material to the tooth.

The matrix band of the prior art is metallic, usually comprising stainless steel. The matrix band must be substantially impervious to, or not reactive with, fluids in a mouth of a person. The matrix band must also be made of a metal that is nontoxic. The basic design and use of dental matrix bands is well-described in U.S. Pat. No. 5,586,883 to Nakisher and Uditsky, the disclosure of which is incorporated herein by reference. Accordingly, the use need not be further described here.

There are a number of different dental matrix bands or devices currently on the market. For example, this is a Universal Adult Matrix Band available in sizes of 0.001 inch and 0.0015 inch, an Adult Molar Matrix Band, a Child Matrix Band Auto Matrix System and Sectional Matrix Band Systems.

Although the matrix band is a common and long-used dental implement, problems do exist with the currently used technology. Blood, saliva and other bodily fluids in the work area can interfere with the dental process by reducing adhesion capabilities and causing deterioration of the cavity filling material. Such body fluids include, but are not limited to, blood, bile and saliva. Interference is caused between the tooth and the filling material, because the best adherence of a filling to a tooth occurs when the tooth is dry, and the mechanical strength of the filling material is maximized. These fluids, especially blood, can also interfere with a proper viewing of the area on which a dentist is working. It is very useful to minimize blood flow and stop it effectively and efficiently when it does occur.

Another difficulty with the use of existing matrix bands is the tendency of the bands to adhere to the cavity filling material. This adherence may make the matrix band difficult to remove from the tooth when the filling process is complete, and may require the dentist to exert extra force on the tooth of a patient in order to remove the band. A difficult removal of the matrix band may well be uncomfortable for the patient, and may also weaken the bond between the cavity filling material and the tooth. Without good bond strength between the filling material and the tooth, the dental filling may fail.

Many devices are known in the prior art which allegedly permit easy removal of a matrix band from a tooth. One attempt to solve the problem includes a matrix band with gold plating. However, while the device may be easier to remove from around a tooth, the gold-plated matrix band does not completely solve or eliminate the ingress of fluid, which results in an undesired body fluid flow into the work area.

While not desired to be bound by any particular theory, capillary action is believed to occur because the solid gold or gold alloy matrix band, as well as a gold-plated matrix band is not soft enough to form a sufficient and proper seal with the tooth. Thus, such a band fails to eliminate the ingress of fluid to the work area due to this capillary action. Certainly other explanations for the failure of the gold, gold alloy and gold-plated matrices may be equally plausible.

Until the device of the present application, these and other problems in the prior art went either unnoticed or unsolved by those skilled in the art. The present device provides a coated dental matrix which performs the basic function of facilitating filling of a tooth without sacrificing adherence quality and while improving seal effectiveness and ease of removability upon completion.

### SUMMARY OF THE INVENTION

Generally speaking, an improved dental matrix band constructed from a thin, flexible strip of pharmaceutically acceptable metal, including titanium, titanium alloy or stainless steel, and coated with titanium or titanium alloy to initiate coagulation of blood and reduce bleeding into the work area. In addition to titanium benefits, the support material having a barrier coating applied to a surface of the flexible titanium or titanium alloy strip to minimizes ingress of fluid to an area between the strip and the tooth to which it is positioned around, is described.

In an embodiment, a matrix band or sectional matrix band for use in dentistry, is described. The matrix band includes a thin, flexible strip of a pharmaceutically acceptable metal coated with titanium or titanium alloy material capable of being positioned around a tooth, a polymer barrier coating applied to one surface of the thin, flexible strip, wherein the polymer barrier coating minimizes ingress of fluid to an area between the thin flexible strip and the tooth to which it is positioned around.

In another embodiment, a dental matrix band seal is described. The dental matrix seal includes a flexible strip having a surface, the strip capable of being positioned around a tooth, a polymer coating applied to one surface of the strip, wherein the polymer coating is in direct contact with an outer surface of the tooth when the flexible strip is positioned around the tooth, and, wherein the polymer coating minimizes ingress of fluid to an area between the strip and the tooth to which it is positioned around minimizing or eliminating contamination from body fluids.

A method for making a polymer coated matrix band is disclosed. The method includes the steps of priming a surface of a flexible strip of material, applying a capillary-action reducing polymer coating to the primed surface of the flexible strip and adhering the coating to the flexible strip. Polymer coatings are typically soft enough to successfully form a seal between the polymer band and the tooth.

In yet another embodiment, a matrix band or sectional matrix band for use in dentistry, is described. The matrix band includes a thin, flexible strip of a pharmaceutically acceptable metal coated with titanium or titanium alloy material capable of being positioned around a tooth, a barrier layer applied to one surface of the thin, flexible strip, wherein the barrier layer minimizes ingress of fluid to an area between the thin flexible strip and the tooth to which it is positioned around.

These and other aspects of the dental matrix band may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 illustrates a perspective view of a titanium or titanium alloy 110 sectional matrix band with a polymer barrier coating layer 120;

FIG. 2 illustrates a plan view of stainless steel sectional matrix band 110 plated with titanium or titanium alloy 112 with a polymer barrier coating layer 120;

FIG. 3 illustrates a cross-sectioned view of the stainless steel matrix band 110 plated with titanium or titanium alloy 112;

FIG. 4 illustrates a cross-sectioned view of the sectional matrix band around a tooth; and,

FIG. 5 illustrates a cross-sectioned view of a straight matrix band or contoured matrix band around a tooth.

### DETAILED DESCRIPTION

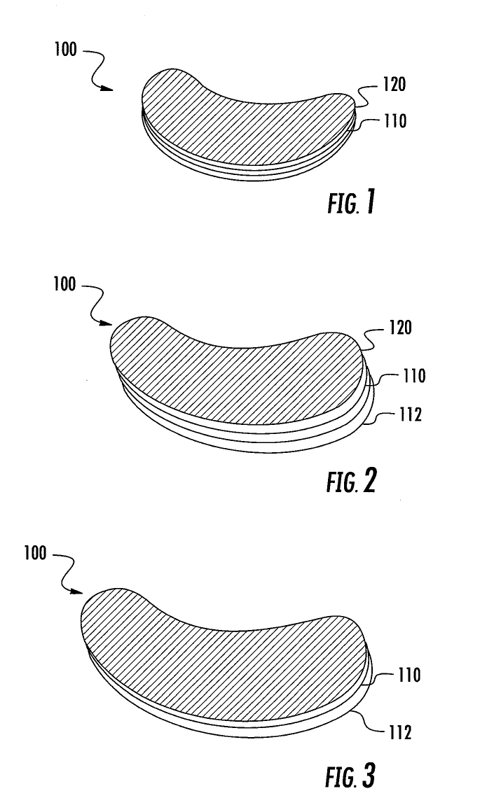

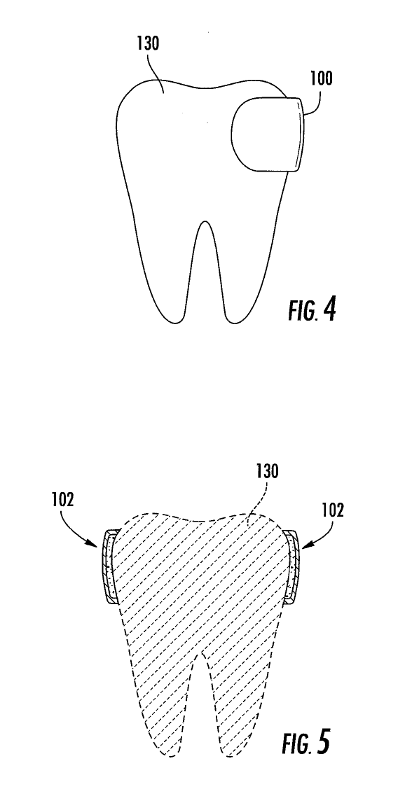

Referring to FIGS. 1-5, there is illustrated a dental matrix band and in particular, a sectional matrix band, generally designated as 100, which is used for dental procedures. It should be understood, that although a section matrix band is illustrated, the present disclosure would be useful for any matrix band including straight 102 and contoured matrix bands. The present matrix band is suitable for use in dental procedures, and in particular, those where fillings are required. During such procedures, it is important to keep blood, saliva and other bodily fluids outs of the work area, for both efficiency and to reduce or prevent contamination. The present matrix band on the market without having a coated surface thereon, results in capillary action between the tooth and the band being at least substantially reduced, if not eliminated.

The concept disclosed and claimed herein may be described as a dental matrix band including a flexible strip of titanium, titanium alloy or stainless steel plated with titanium or titanium alloy with a polymer seal, and is applicable to any dental matrix device, regardless of the geometric shape of the dental matrix device, including straight and simple contoured fully contoured, and Section Matrix Band Systems. The geometric shape of the matrix band is otherwise irrelevant to the function of the device.

Referring now to FIGS. 1-4, a sectional matrix band 100 is illustrated. The matrix band 100 includes a thin, flexible strip or support base 110 of material, either stainless steel, titanium or titanium alloy, having a barrier layer 120, the strip of titanium, titanium alloy or stainless steel plated with titanium or titanium alloy 112 being capable of positioning around a tooth 130. The barrier layer, which may be a polymer barrier layer 120, is applied to the surface of the thin, flexible strip 110 made of titanium, titanium alloy or stainless steel plated with titanium or titanium alloy 112. When the matrix band 100 is positioned around the tooth 130, the barrier layer 120 is positioned toward the outer surface of the tooth 130 to be worked on. (FIG. 4).

The flexible strip or support base 110 may be composed of any pharmaceutically suitable metal, including stainless steel, titanium or titanium alloys. Titanium (unalloyed) or alloys including titanium are preferred materials for construction of the dental matrix band. Optionally, the strip 110 may be constructed from titanium, titanium alloy or stainless steel support base 110 plated with titanium or titanium alloy 112 and a polymer coating 120 applied using suitable techniques. The strip 110 of titanium, titanium alloy or stainless steel plated with titanium or titanium alloy material 112 has a thickness ranging from about 0.001″ to about 0.0015″.

A polymer barrier layer 120 with a thickness in the range of from 0.0001″ to 0.001″ is adequate to reduce capillary action. A barrier coating layer 120 with a thickness in the range of from about 0.0001″ to 0.0003″ is most effective in reducing, if not eliminating, capillary action. The barrier coating layer 120 can be applied in a continuous or substantially continuous layer.

The barrier layer 120 is a suitable polymer, one that inhibits or prevents the egress of fluid and adheres to the metal strip. Suitable polymers include silicone and polysiloxane. The polymer coating may be applied over the titanium coating, if desired.

Adhesion of the polymer barrier coating 120 as dental matrix seal to any dental matrix device is assured by priming or etching the surface of the dental matrix metal device using known methods. Etching of the matrix band may be accomplished in any suitable fashion. Acid etching and photochemical etching are especially suitable processes for etching the matrix band, as long as the procedures are pharmaceutically acceptable. Pharmaceutically acceptable includes those materials suitable for use in a mouth of a person.

Additionally, the matrix band may be etched by using mechanical abrasion. Mechanical abrasion may be obtained by subjecting the metal surface to a high velocity stream of silica particles or soft metal particles, or by rubbing the surface with a silica or diamond encrusted paper or metal sheet. Clearly, any abrasive system may be used. However, the chemical treatment is preferred.

Referring to FIGS. 4 and 5, the titanium, titanium alloy or stainless steel coated with titanium or titanium alloy matrix band 100 or sectional matrix band is shown in use in a dental procedure. FIG. 4 illustrates the sectional matrix band 100, while FIG. 5 illustrates a straight matrix band 102. Regardless of the shape, the matrix band 100 with a polymer barrier coating 120 is wrapped around the tooth 130 to be restored using dental restoration. The polymer barrier coating 120 provides a seal between the flexible strip 110 and the tooth 130 to which it is positioned around. The matrix band material of titanium, titanium alloy or stainless steel coated with titanium or titanium alloy 112 initiates the clotting process and reduces bleeding in the work area around the tooth, to eliminate or reduce contamination.

In the following examples, which are intended to illustrate without unduly limiting the invention disclosed herein, all parts and percentages are by weight, unless otherwise specified.

### EXAMPLE ONE

A section coated matrix band 100 having a polymer layer 120 applied onto a titanium, titanium alloy or stainless steel 110 plated with titanium or titanium alloy 112 using known methods. The section matrix band 100 is used as one component of the matrix system, which includes section matrix retainers, wedges, adjacent tooth guards, instruments and matrix band. The section matrix band 100 of the present disclosure is applied to a tooth 130 under repair, to either protect the adjacent teeth during preparation and repair, and/or to contain a restorative material before curing. Although dental filling procedures requiring the use of matrix bands are generally limited to the restoration of bicuspids and molars, it should be appreciated that the present invention is not limited to any particular dental procedure or to the application of a dental procedure to any particular type of tooth.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

1. A matrix band or sectional matrix band for use in dentistry comprising:
a thin, flexible strip of pharmaceutically acceptable metal having two opposing surfaces;
a coating at least partially covering one surface of the flexible strip with one of either titanium or a titanium alloy material, the coating having a thickness in the range of from 0.001 inch to about 0.0015 inch, the strip being configured for positioning around a tooth; and
a polymer barrier layer coating applied to the other surface of the thin, flexible strip and having a thickness in the range of from 0.0005 inch to about 0.001 inch;
wherein, when positioned around a tooth, the titanium or titanium alloy coating initiates clotting of blood and the polymer barrier layer minimizes ingress of fluid to an area between the thin, flexible strip and the tooth to which it is positioned around.

2. The matrix band or sectional matrix band of claim 1, wherein the pharmaceutically acceptable metal is selected from the group consisting of titanium, titanium alloy and stainless steel.

3. The matrix band or sectional matrix band of claim 1, wherein the polymer barrier layer comprises a pharmaceutically acceptable material.

4. The matrix band or sectional matrix band of claim 3, wherein the pharmaceutically acceptable polymer comprises one of either silicone and polysiloxane.

5. (canceled)

6. The matrix band or sectional matrix band of claim 1, wherein the polymer barrier layer is configured to provide a seal between the flexible metal strip and a tooth to which it is positioned around.

7-14. (canceled)
